(19) United States
(12) Patent Application Publication
(10) Pub. No.: US 2014/0089038 A1
(43) Pub. Date: Mar. 27, 2014

(54) APPLYING OF SOCIAL MEDIA METRICS FOR SUPPLIER EVALUATION

(71) Applicants: Ramin Bagheri, Los Altos, CA (US); Christopher Salis, San Francisco, CA (US)

(72) Inventors: Ramin Bagheri, Los Altos, CA (US); Christopher Salis, San Francisco, CA (US)

(73) Assignee: SAP AG, Walldorf (DE)

(21) Appl. No.: 13/627,201

(22) Filed: Sep. 26, 2012

(51) Int. Cl. G06Q 10/00

(52) U.S. Cl. 705/7.28; 705/7.39

(57) ABSTRACT

In an example embodiment, supplier management is performed first by defining one or more social media metrics pertaining to a supplier brand of interest, with the one or more social media metrics being based on data gathered from social media. These metrics may then be used to analyze values from one or more social media websites. Weights can be assigned to the values, and a score for the supplier brand of interest can be determined, based on the weighted values for the one or more social metrics and based on weighted values for one or more other metrics. The score can then be presented to a user via a graphical user interface.

### TECHNICAL FIELD

This document generally relates to systems and methods for use with supplier evaluation. More specifically, this document relates methods and systems for applying social media metrics for supplier evaluation.

### BACKGROUND

Supplier evaluation refers to the process of evaluating and approving potential suppliers of a business using factual and measurable assessment. Supplier relationship management (SRM) refers to the management of various aspects of supplier relationships, of which supplier evaluation is one aspect, and generally involves introducing various software packages to aid businesses in evaluating suppliers. Many SRM solutions utilize a score card, wherein several metrics, such as financial data, delivery performance, logistics capabilities, processes capabilities and other metrics are examined for each supplier.

### BRIEF DESCRIPTION OF DRAWINGS

The present disclosure is illustrated by way of example and not limitation in the figures of the accompanying drawings, in which like references indicate similar elements and in which:

FIG. 1 depicts an application landscape, in accordance with an example embodiment

FIG. 2 illustrates a purchase order environment, in accordance with an example embodiment.

FIG. 3 is a diagram illustrating an SRM server architecture, in accordance with an example embodiment.

FIG. 4 is a diagram illustrating general categories of a decision making process in supplier evaluation, in accordance with an example embodiment.

FIG. 5 is a flow diagram illustrating a process for integrating social media into supplier relationship management, in accordance with an example embodiment.

FIG. 6 is a diagram illustrating an example weighting, in accordance with an example embodiment.

FIG. 7 is a screen capture illustrating the defining of the weighting, in accordance with an example embodiment.

FIG. 8 is a flow diagram illustrating a process for integrating social media into supplier relationship management, in accordance with another example embodiment.

FIG. 9 is a screen capture illustrating the reporting of various metrics, in accordance with an example embodiment.

FIG. 10 is a block diagram of a computer processing system at a server system, within which a set of instructions, for causing the computer to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

More and more businesses are developing active social media presences. While businesses may know how in use social media for marketing and customer relationship management (CRM), in an example embodiment, social media presence is leveraged for aiding with supplier evaluation.

Scorecard evaluation traditionally has focused on internal evaluation by the buying company regarding the supplier. In an example embodiment, social media metrics from outside the buying company are used to enhance supplier evaluation results.

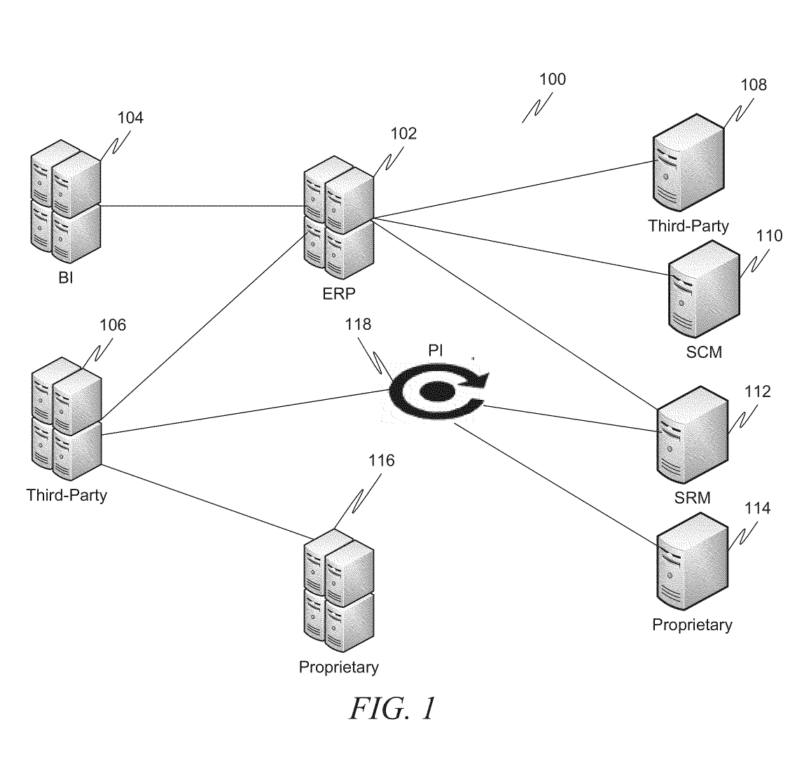

FIG. 1 depicts an application landscape, in accordance with an example embodiment. The application landscape 100 comprises different heterogeneous software and/or hardware components 102 to 116, which are connected to each other as shown by the solid lines in FIG. 1, and which may operate together in the application landscape 100 to process, for example, a business scenario. The application landscape 100 may comprise an enterprise resource planning system (ERP) 102. The ERP 102 may integrate internal and external management information across an entire organization, embracing different activities and/or services of an enterprise. The ERP 102 automates the activities and/or services with an integrated computer-based application. The ERP 102 can run on a variety of hardware and/or network configurations, typically employing a database to stare its data. The ERP 102 may be associated with (e.g. directly or indirectly connected to and/or in (networked) communication with) a business intelligence (B1) component 104, one or more third parties 106 and 108, a supply chain management (SCM) component 110, and/or a SRM component 112. The SRM 112 and/or the SCM 110 may further be associated with at least one proprietary service 114. Furthermore, at least one of the third parties 106 may also be associated with at least one proprietary service 116. The B1 component 104 may provide historical, current, and predictive views of business processes and/or business scenarios, for example, performed on the ERP 102. Common functionality of business intelligence technologies may comprise reporting, online analytical processing, analytics, data mining, business performance management, benchmarking, text mining, and/or predictive analytics. Use functionality may be used to support better decision making in the ERP 102. The SCM component 110 may manage a network of interconnected businesses involved in the provision of product and/or service packages required by end consumers such as the ERP 102. The SCM component 110 may span movement and storage of raw materials, work-in-process inventory, and finished goods from point of origin to point of consumption (also referred to as a supply chain). The SRM component 112 may specify collaborations with suppliers that are vital to the success of the ERP 102 (e.g., to maximize the potential value of those relationships). All of these systems may be integrated via a process integration component 118.

It should be noted that while this disclosure describe the use of Supplier Relationship Management systems, example embodiments can be implemented on Supplier Lifecycle Management systems. Supplier Lifecycle Management is a holistic approach to managing supplier relationships. It deals with the supply base as a whole to constantly determine the right mix of suppliers. It covers the lifecycle of individual suppliers—from onboarding to a continuous development. For purposes of this disclosure, the term “supplier management” shall be interpreted as encompassing either Supplier Relationship Management or Supplier Lifecycle Management tools (or both).

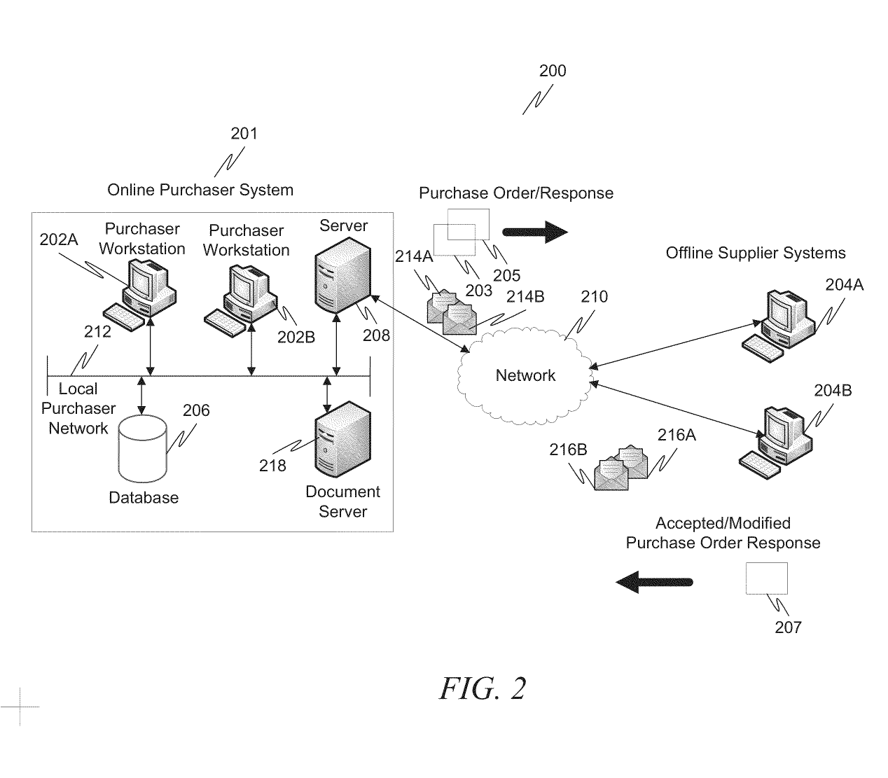

FIG. 2 illustrates a purchase order environment 200, in accordance with an example embodiment. Online purchaser system 201 may be used to provide emulation of online purchase order processing to offline supplier systems 204A, 204B. Online emulation may be initiated by the purchaser system 201 to offline supplier systems 204A, 204B by generating for each supplier a purchase order 203 and purchase order response 205. The purchase order 203 and the purchase order response 205 may be sent to a supplier as one or more attachments to e-mails 214A, 214B. In one example embodiment, the purchase order 203 and the purchase order response 205 may be a single electronic document that is transmitted via the same e-mail. In an alternate example embodiment, the purchase order 203 and the purchase order response 205 may each be an electronic document and sent via the same email, or the purchase order response 205 may be sent in a subsequent e-mail, which follows shortly after acknowledgement of receipt of the purchase order 203.

In another alternate example embodiment, an order confirmation is sent. The order confirmation may be sent as a third portion of an attachment of the email, as a seperate attachment of any emails 214A, 214B or instead of the purchase order response 205. The order confirmation may be the same as the purchase, order respond 205 except for a variation in the fields included.

The purchaser system 201 is connected to network 210, which may be, for example, the Internet or World Wide Web, to transmit e-mails 214A, 214B. The network 210 is also connected to offline supplier systems 204A, 204B, via, for example, supplier mail servers, so that e-mails 204A, 204B may be received by the offline supplier systems 204A, 204B.

The offline supplier systems 204A, 204B may be any processing device including a personal computer (PC), laptop computer, personal digital assistant (PDA), mobile device, or telephone that can be used as a computer system by a supplier. In an alternate example embodiment, the supplier's computer system comprises a supplier workstation that is connected via, for example, a local area network (LAN) or wide area network (WAN), to other components of a supplier computer network.

The offline supplier systems 204A, 204B receive e-mail 214A, 214B while connected to the purchaser system 201 via the network 210. A supplier may connect and disconnect the offline supplier systems 204A, 204B from network 210. While the offline supplier systems 204A, 204B are connected to network 210, the offline supplier systems 204A, 204B operate in an online mode and may communicate directly with any system connected to network 210, such as purchaser system 201. When the offline supplier systems 204A, 204B is not connected to network 210, the offline supplier systems 204A, 204B operate in an offline mode and cannot communicate with, for example, the purchaser system 201.

In an alternate example embodiment, the offline supplier systems 204A, 204B operate in offline mode and receive the purchase order 203 and the purchase order response 205 via a transportable electronic medium that does not require connection to the network 210. Exemplary transportable electronic mediums that do not require connection to the network 210 are digital video disk or digital versatile disks (DVDs). Universal Serial Bus (USB) thumb drives, mobile devices such as mobile phones, and/or compact disk read only memories (CD-ROMs) that may be sent via delivery service or U.S. mail.

While operating in off-line mode, the offline supplier systems 204A, 204b may display the purchase order 203 and the purchase order response 205, and query the supplier for changes to the purchase order response 205. The supplier may review the purchase order response 205 and modify its contents in accordance with what the supplier can accommodate or accept all of the purchaser's terms, and save this input in a responsive purchase order response 207 (also referred to as accepted/modified purchase order response 207). The supplier can then attach responsive purchase order response 207 to another e-mail 216A, 216B, connect to the network 210, and send a responsive purchase order response back to the purchaser. The responsive purchase order response 207 can then be uploaded back into the online purchaser system 201.

In an example embodiment, the purchaser system 201 may comprise purchaser workstations 202A, 202B that are connected to a database 206, server 208, and document server 218 via local purchaser network 212. The purchaser workstations 202A, 202B may be used by a purchaser to generate and send the purchase order 203, the purchase order response 205, and the order confirmation. These documents may be generated by, for example, the server 208 using internal work requests stored by the server 208 or the database 206. The purchaser system 201 may run a supplier relationship software application, such as mySAP SRM on, for example, the sender 208. SRM software may provide automated visibility into supplier relationship processes such as order fulfillment distribution and management, collaborative product design, and supply management. Emulation of online purchase order processing may be used to increase automation for purchasers by automatically uploading data received in responsive purchase order responses 207 and/or the responsive order confirmation into the server 208 or the database 206 so that it can be used by the supplier relationship management processes.

The server 208 may be, for example, my device that can provide supplier relationship management functionality by processing instructions written in, for example, an object-oriented programming language such as Java or C++. The server 208 may also be used to transmit e-mails 214A, 214B and receive e-mails 216A, 216B from the supplier. In an alternate example embodiment, another server is used to transmit e-mails 214A, 214B and receive e-mails 216A, 216B. The server 208 may be connected to database 206, which may be any set of data stored in a file format on any machine readable medium, to store and retrieve data. For example, the purchase order 203 and the purchase order response 205 may be stored in the database 206.

In an example embodiment, new metrics are defined that consider additional factors. Specifically, these new metrics consider factors coming from a social network. In order to obtain this data, a web analyzer vendor can provide the data via an application programming interlace (API) or a comma-separated values (CSV) file, for example. This data could then be combined with other metrics in the SRM system.

A social network may be defined as any outside network, online service, platform, or site that focuses on facilitating the building of social networks or social relations among people who, for example, share interests, activities, backgrounds, or real-life connections. Various communications on these social networks can be monitored, such as message board postings, ratings provided by users, and text information sent in, for example, “tweets,” news articles, blogs, and the like.

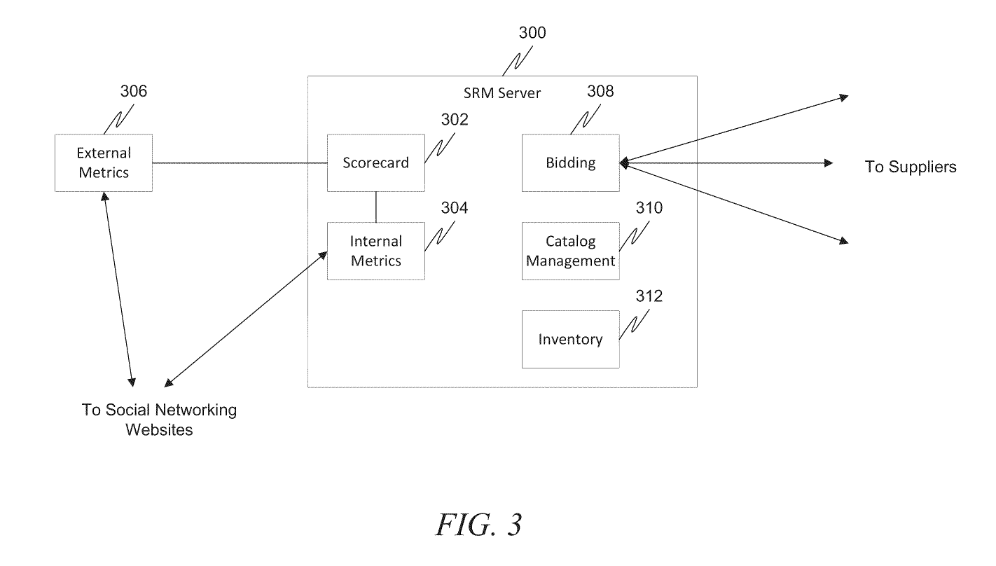

FIG. 3 is a diagram illustrating an SRM server architecture, in accordance with an example embodiment. As can be seen, the SRM server 300 may contain a scorecard 302, which is used to present various metrics to a user. The scorecard 302 may integrate metrics from an internal metrics module 304 and an external metrics module 306. The external metrics module 306 may be compiled by, for example, a third party, although in some embodiments the external metrics 306 may be compiled by other components local to the purchaser's system, but outside of the SRM server 300.

Either or both of this internal metrics module 304 and external metrics module 306 may obtain information from social networking websites in order to calculate one or more metrics. Also contained in the SRM server 300 are bidding 308, catalog management 310, and inventory modules 312. Bidding module 308 manages bids from suppliers. Catalog management module 310 manages the catalog of products, inventory module 312 manages the inventory levels of the products.

Generally, factors used by the scorecard 302 may be classified into three categories: supplier risk mitigation, sustainable procurement, and buyer relationship management. Supplier risk mitigation involves factors that are relevant in analyzing various risks with utilizing the supplier. This may include, for example, the risk that the supplier may not be able to supply the desired goods and/or services for various reasons. These reasons could include, for example, natural disasters (e.g., a tsunami wiping out a factory), financial risks (e.g., the supplier's finances are not on solid footing), or social risks (e.g., the supplier may be subject to boycotts or other social or political pressure, for example, if it is discovered that they contract with companies who utilize child labor). The various factors involved in this category may involve supplier risk awareness and determination of negative sentiment, obtaining “early bird” messages from other customers of suppliers (helpful for financial health, for example), and supplier product risk (e.g., a supplier of the supplier may be having trouble fulfilling requirements).

Sustainable procurement evolves involves that are relevant in analyzing how likely it is that the supplier can deliver the goods and/or services and will continue to be able to do so throughout the length of the relationship. The various factors involved in this category may involve social auditing and monitoring, determining the transparency of the supplier footprint (e,g., which suppliers supply the supplier), and tracing whether boycotts or other social activities could cause a supplier to be unable to fulfill the requirements of the relationship.

Buyer relationship management involves factors relevant to determining how good it supplier will be. The various factors involved in this category involve participating in industry and special buyer interest groups, customer surveys (e.g., what other buyers felt about the supplier), feedback received from other buyers in response to published buyer views, crowdsourcing and group buying, and results from joint audits. As can be seen, some factors may overlap in these categories.

In an example embodiment, several brand new social media-related factors use defined as follows. First, a factor known as “share of voice” may be defined. The share of voice is the ratio of mentions of the supplier brand to the overall mentions of products/services in the area of the supplier brand. These overall mentions may be measured by determining the number of mentions of the suppliers brand as well as the number of mentions of competitor products/services to the supplier's brand. This way be represented by the following equation:

$$Share of Voice = \frac{Brand Mentions}{Total Mentions ( Brand + Competitor A , B , C … n )}$$

Mentions, of course, could be determined based on a number of different social media sources.

Second, a factor known as “audience engagement” may be defined. This factor attempts to measure how engaged the audience (social media audience to be exact) is with the supplier's brand. This may be determined by measuring the number of mentions of the supplier's brand, as well as the number of times the supplier's brand has been “shared” with other users (many social networking platforms allow users to “share” links or articles with other users when they find the link or article to be of interest), as well as trackbacks (a trackback is one type of linkback method allowing website authors to request notification when someone links to one of their documents). This may be represented by the following equation:

$$Audience Engagement = \frac{Brand MentionsComment + Shares + Trackbacks}{Total Views}$$

Thus, audience engagement measures the ratio of expressions of audience engagement to the number of overall views the audience has given to the supplier's brand. If the audience engagement ratio, is lows this means that the number of people “talking about” the supplier's brand in social networks is low in comparison to how many people are aware of the supplier's brand.

Third, a factor known as “conversation reach” may be defined. This is the ratio of total people participating in conversations about the supplier's brand to the total amount of audience exposure. This may be represented by the following equation:

$$Conversation Reach = \frac{Total People Participating}{Total Audience Exposure}$$

The total amount of audience exposure can be calculated based on content, either the shared content or the replied content. For example, if counting Facebook and Twitter, the total people participating may be the number of people “liking” or retweeting conversations about the brand, whereas the total audience exposure may be the number of people receiving or viewing the conversation.

Fourth, a factor known as a “satisfaction score” may be defined. This is the ratio of customer feedback about the supplier's brand to all customer feedback. This may be represented by the following equation:

$$Satisfaction Score = \frac{Customer Feedback ( input A , B , C … n )}{All Customer Feedback}$$

Different key performance indicators may be used for this metric. For example, a “follow” rate can be determined by measuring the number of different customers who have provided feedback who also “follow” the brand on a social networking website. Another key performance indicator that could be used is “supplier's customer engagement time,” which is how much time, on average, a customer spends on the supplier's website. Another key performance indicator that could be used is positive and negative customer mentions in different social media platforms.

Fifth, a factor known as “sentiment ratio” can be defined. This is the ratio of positive, neutral, and negative mentions of the supplier's brand to all brand mentions. This may be presented by the following equation:

$$Sentiment Ratio = \frac{Positive \text{:} Neutral \text{:} Negative Brand Mentions}{All Brand Mentions}$$

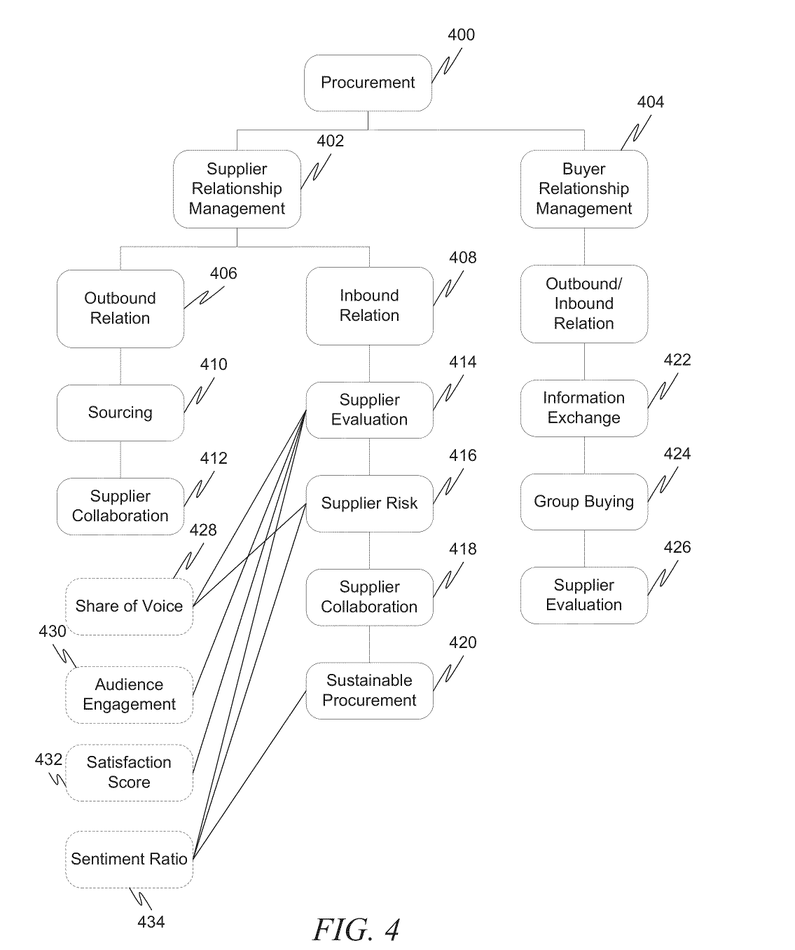

These new factors defined stove can be used in the factor categories described above as well as other categories. FIG. 4 is a diagram illustrating general categories of a decision making process in supplier evaluation, in accordance with an example embodiment. Under the auspices of procurement 400, there may be two main management categories: supplier relationship management 402, and buyer relationship management 404.

Within supplier relationship management 402, there are categories relating to outbound relation 406 and inbound relation 408. Under outbound relation 406, there are categories such as sourcing 410 and supplier collaboration 412. Under inbound relation 408 there are categories such as supplier evaluation 414, supplier risk 416, supplier collaboration 418, and sustainable procurement 420.

Under buyer relationship management 404, there are categories such as information exchange 422, group buying 424, and supplier evaluation 426.

Also depicted in this figure are various examples of how the newly defined factors described above can fit into this schema. Specifically, the “share of voice” factor 428 may a affect supplier evaluation 414, The “audience engagement” factor 430 may also affect supplier evaluation 414, as might the satisfaction score 432. Some factors may affect multiple categories. The sentiment ratio 434, for example, may affect supplier evaluation 414 as well as supplier risk 416 and sustainable procurement 420 (because poor customer sentiment may lead to the supplier going out of business or discontinuing a product or service). Likewise, “share of voice” 428 described above may also affect supplier risk 416 and supplier evaluation 41 (because a company being talked about a lot may be being talked about in a negative way (i.e., bad press)) which may portend a scandal or disaster.

Thus, additional metrics and evaluation criteria (e.g., in the scorecard) can be based on social media. Furthermore, various metric tools, including, for example, third party metric tools, can be used and integrated within an SRM system. These metric tools can be imported into the scorecard. Furthermore, performance measures, targets, and assessments could be shared with the suppliers, to encourage them to improve performance.

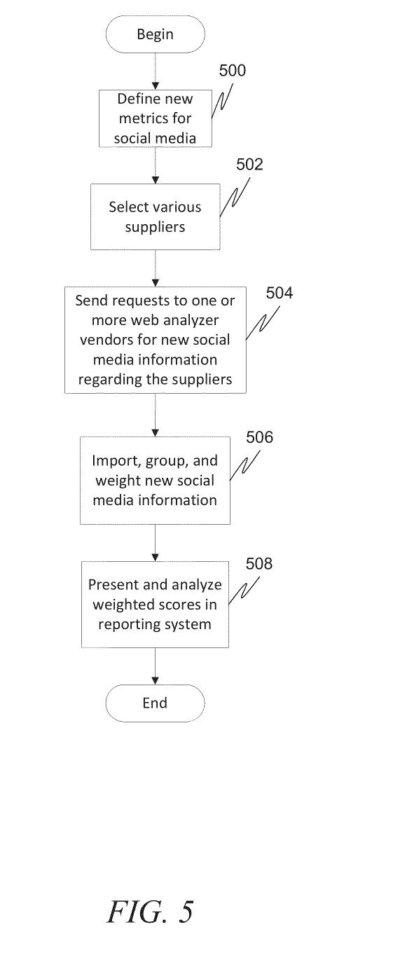

FIG. 5 is a flow diagram illustrating a process for integrating social media into supplier relationship management in accordance with an example embodiment. At 500, various new metrics for social media, such as the factors described above, can be defined. At 502, various suppliers can be selected. At 504, requests can be sent to one or more web analyzer vendors for new social media information regarding the suppliers. This offloads the gathering of social media data off the SRM module. One example of such a web analyzer vendor is radiant.

The request for information may include the newly defined metrics calculated by the web analyzer vendor using their data. In one example embodiment, a single web analyzer vendor is utilized. In another example- embodiment, multiple web analyzer vendors may be utilized. In the multiple web analyzer vendor embodiment, one possibility is to send certain metrics to certain vendors while other metrics are sent to other vendors. For example, one particular web analyzer vendor may be better suited to compute the “share of voice” metric, whereas another web analyzer vendor may be better suited to compute the “satisfaction score.” Appropriate metrics can be sent us the web analyzer vendors best suited to the task. Alternatively, the same metrics can be sent to multiple web analyzer vendors for redundancy purposes (possibly averaging the results from each, or discarding outliers).

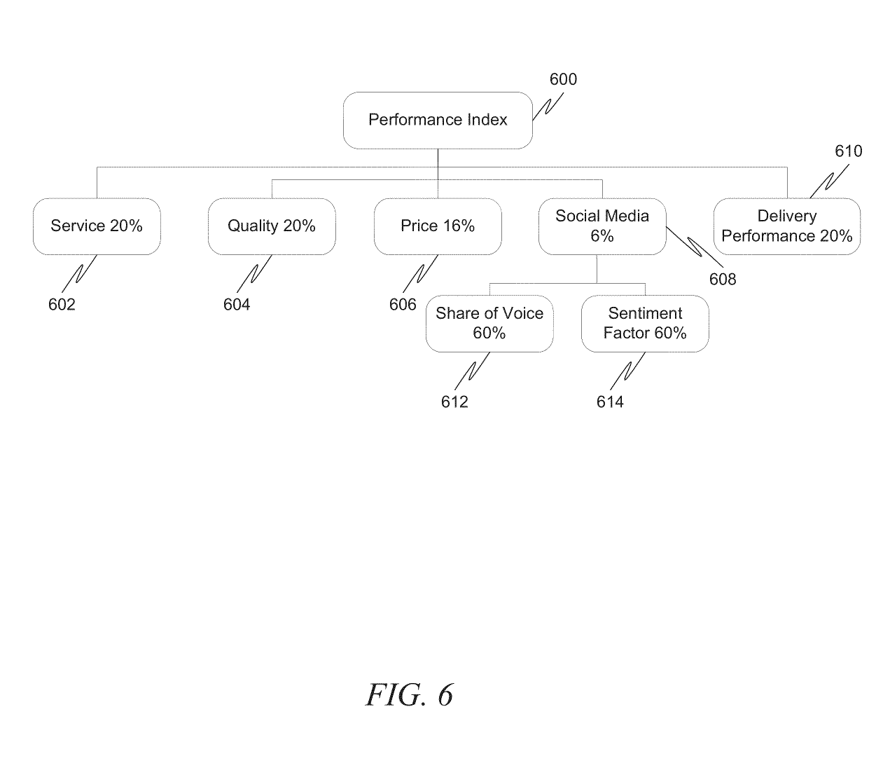

At 506, when new social media data is received from a web analyzer vendor, it is imported, grouped, and combined with other factors and assigned a weight. FIG. 6 is a diagram illustrating an example weighting, in accordance with an example embodiment. Here, a performance index 600 for a supplier may be weighted based on general categories of factors. Here, a 20% weight applies to service 602, 20% weight to quality 604, 16% to price 606, 6% to social media 608, and 20% to delivery performance 610. Each category may be made up of various metrics, each of which themselves can be assigned a weight within the category. Within social media 608 for example, 50% may be weighted for share of voice 612 and 50% for sentiment factor 614.

Referring back to FIG. 5, the scores may be presented and analyzed using a reporting system at 508.

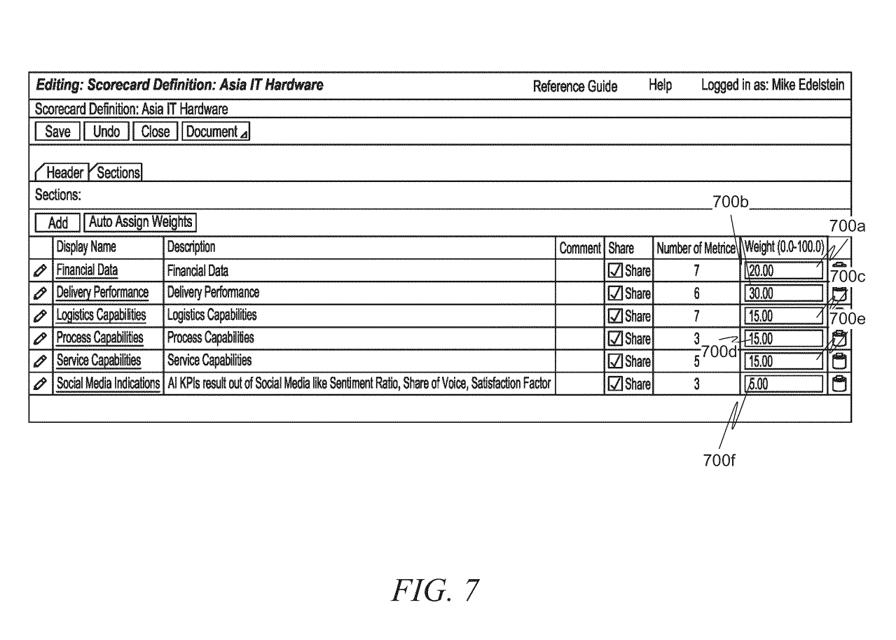

If The weighting described in 506 and depicted in FIG. 6 can be defined by a user of the reporting system. FIG. 7 is a screen capture illustrating the defining of the weighting, in accordance with an example embodiment. Here, the user may enter the various weights into various fields 700a-700f within the reporting system.

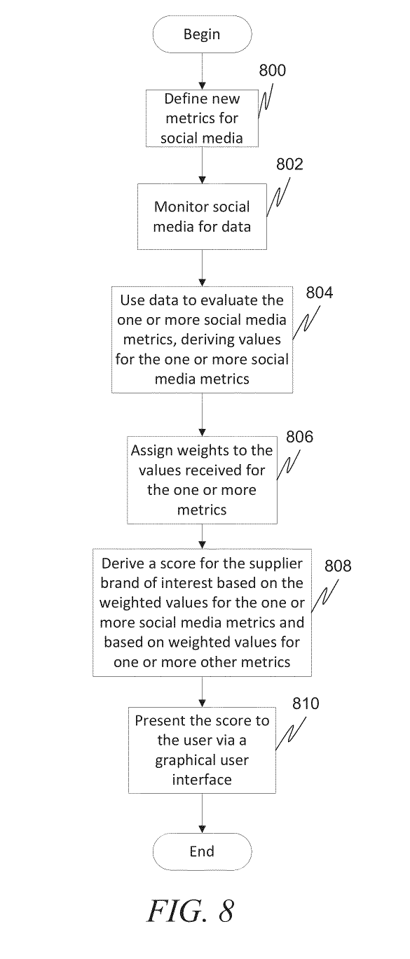

FIG. 8 is a flow diagram illustrating a process for integrating social media into supplier relationship management, in accordance with another example embodiment. Here, rather than relying on a web analyzer vendor, the system gathers data about social media directly. At 800, one or more social media metrics pertaining to a supplier brand of interest are defined, with the one or more social media metrics being based on data gathered from social media. At 802, social media is monitored for data. At 804, the data is used to evaluate the one or more social media metrics, thereby deriving values for the one or more social media metrics. At 806, weights are assigned to the values received for the one or mote social media metrics. At 808, a score is derived for the supplier brand of interest based on the weighted values for the one or more social media metrics and based on weighted values for one or more other metrics. At 810, the score is presented to a user via a graphical user interface.

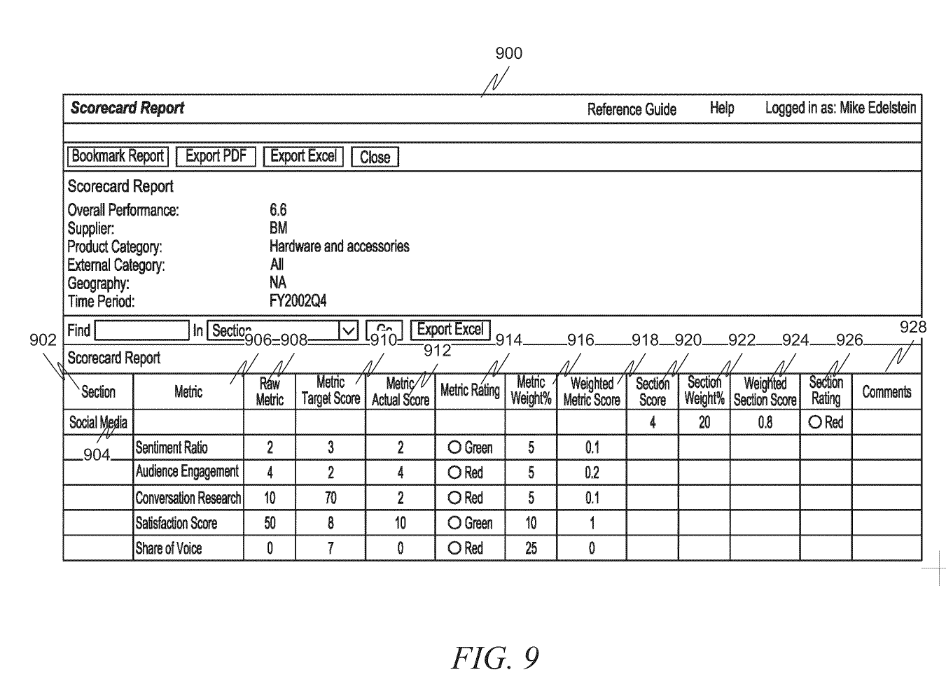

FIG. 9 is a screen capture illustrating the reporting of various metrics, in accordance with an example embodiment. Here, a scorecard report 900 is depicted. The scorecard report 900 may include a number of sections 902. Here, the social media section 904 is depicted. As can be seen, various aspects of each of the social media metrics 906 can be presented to the user, including a raw metric 908, metric target score 910, metric actual score 912, metric rating 914 (green meaning good, red meaning bad), metric weight percentage 916, weighted metric score 918, a score for the section 920, a section weight 922, a weighted section score 924, a rating for the whole section 926 (green meaning good, red meaning bad), and user-defined comments 928.

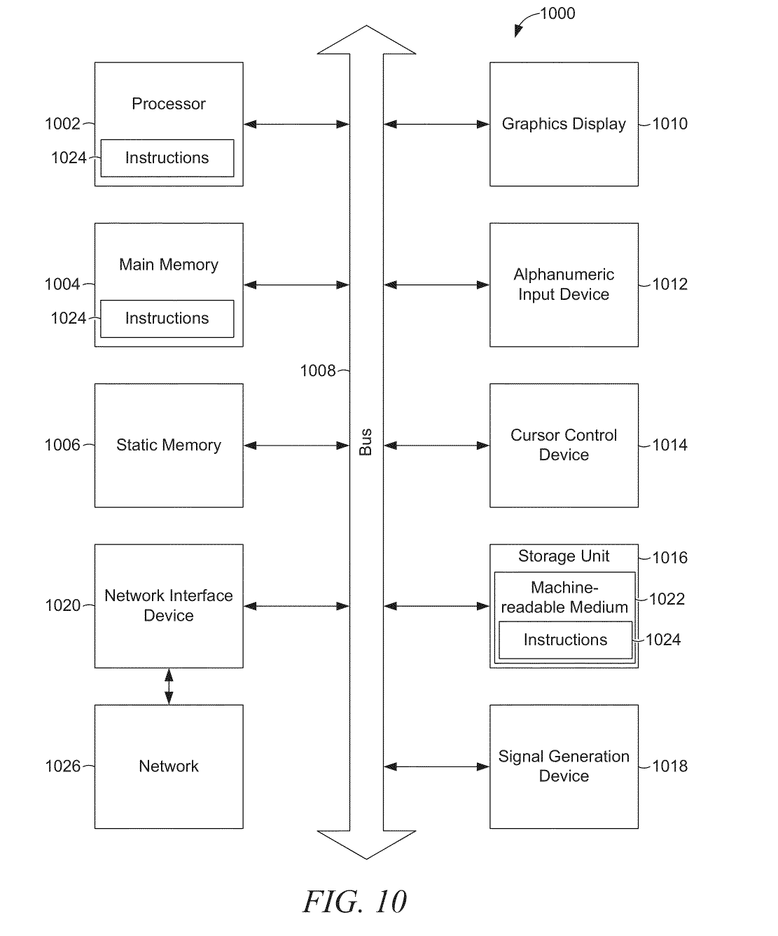

FIG. 10 is a block diagram of a computer processing system at a server system, within which a set of instructions, for causing the computer to perform any one or more of the methodologies discussed herein, may be executed.

Embodiments may also, for example, be deployed by Software-as-a-Service (SaaS), Application Service Provider (ASP), or utility computing providers, in addition to being sold or licensed via traditional channels. The computer may be a server computer, a PC, a tablet PC, a set-top box (STB), a PDA, cellular telephone, or any processing device capable of executing a set of instructions (sequential or otherwise) that specify actions to be taken, by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 1000 includes processor 1002 (e.g., a central processing unit (CPU ), a graphics processing unit (GPU), or both), main memory 1004 and static memory 1006, which communicate with each other via bus 1008. The processing system 1000 may further include graphics display unit 1010 (e.g., a plasma display, a liquid crystal display (LCD) or a cathode ray lube (CRT)). The processing system 1000 also includes alphanumeric input device 1012 (e.g. a keyboard), a user interface navigation device such as a cursor control device 1014 (e.g., a mouse, touch screen, or the like), a storage unit 1016, a signal generation device 1018 (e.g., a speaker), and a network interface device 1020.

The disk drive unit 1016 includes computer-readable medium 1022 on which is stored cue or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the processing system 1000, with the main memory 1004 and the processor 1002 also constituting computer-readable, tangible media.

The software 1024 may further be transmitted or received over network 1026 via a network interface device 1020 utilizing any one of a number of well-known transfer protocols (e.g., hypertext transfer protocol (HTTP)).

White the computer-readable medium 1022 is shown in an example embodiment, to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer and that cause the computer to perform any one or more of the methodologies of the present application, or that is capable of storing, encoding or carrying data structures utilized by or associated with such a set of instructions. The term “computer-readable medium” shall accordingly be taken to include, but not be limited to, solid-state memories, and optical and magnetic media.

While various implementations and exploitations are described, it will, be understood that these embodiments are illustrative and that the scope of the claims is not limited to them. In general techniques for maintaining consistency between data structures may be implemented with facilities consistent with any hardware system or hardware systems defined herein. Many variations, modifications, additions, and improvements are possible.

Plural instances may be provide for components, operations or structures described herein as a single instance. Finally, boundaries between various components, operations, and data stores are somewhat arbitrary, and particular operations are illustrated so the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims.

While the embodiments are described with reference to various implementations and exploitations, it will be understood that these embodiments are illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “computer readable medium” is used generally to refer to media such as main memory, secondary memory, removable storage, hard disks, flash memory, disk, drive memory, CD-ROM and other forms of persistent memory. It should be noted that program storage devices, as may be used to describe storage devices containing executable computer code for operating various methods, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fail within the scope of the claims and their equivalents.

What is claimed is:

1. A method of performing supplier management the method comprising:
defining one or more social media metrics pertaining to a supplier brand of interest, the one or more social media metrics being based on data gathered from social media;
transmitting the one or more social media metrics to a web analyzer vendor;
receiving values for the one or more social media metrics from the web analyzer vendor;
assigning weights to the values received for the one or more metrics;
deriving a score for the supplier brand of interest based on the weighted values for the one or more social metrics and based on weighted values for one or more other metrics; and
presenting the score to a user via a graphical user inter face.

2. The method of claim 1, wherein the one or more social media metrics include at least one metric relevant to evaluating supplier risk.

3. The method of claim 1, wherein the one or more social media metrics include at least one metric relevant to evaluating sustainable procurement.

4. The method of claim 1, wherein the one or more social media metrics include at least one metric relevant to evaluating supplier collaboration.

5. The method of claim 1, wherein the one or more social media metrics include a metric for share of voice.

6. The method of claim 1, wherein the one or more social media metrics include a metric for audience engagement.

7. The method of claim 1, wherein the one or more social media metrics include a metric for conversation reach.

8. The method of claim 1, wherein the one or more social media metrics include a metric for satisfaction score.

9. The method of claim 2, wherein the one or more social media metrics include a metric for sentiment ratio.

10. A method of performing supplier management, the method comprising:
defining one or more social media metrics pertaining to a supplier brand of interest, the one or more social media metrics being based on data gathered from social media;
monitoring social media for data;
using the data to evaluate the one or more social media metrics and deriving values for the one or more social media metrics;
assigning weights to the values derived for the one or more metrics;
deriving a score for the supplier brand of interest based on the weighted values for the one or more social metrics and based on weighted values for one or more other metrics; and
presenting the score to a user via a graphical user interface.

11. The method of claim 10, wherein the presenting includes providing a color-coded indication of the score, relative to a predetermined threshold.

12. The method of claim 10, wherein the weights assigned to the values received for the one or more metrics arc dynamically configurable by the

13. A supplier management server comprising:
a processor;
a memory;
an internal metric module configured to define one or more social media metrics pertaining to a supplier brand interest, the one or more social media metrics being based on data gathered from social media, and to use data from social media to evaluate the one or more social media metrics and derive values for the one or more social media metrics; and
a scorecard module configured to assign weights to the value received from the one or more metrics, derive a score for the supplier brand of interest based on the weighted values for the one or more social metrics and based on weighted values for one or more other metrics, and present the score to a user via a graphical user interface.

14. The supplier management server of claim 13, wherein the scorecard module is further configured to assign weights to values received from one or more metrics from an external metric module; and
wherein the score is also based on the weighted values for the one or more metrics from the external metric module.

15. The supplier management server of claim 13, wherein the external metric module is operated by a third party.

16. The supplier management server of claim 13, further comprising a bidding module communicatively coupled to one or more suppliers.

17. The supplier management server of claim 13, further comprising a catalog management module.

18. The supplier management server of claim 13, further comprising an inventory module.

19. A non-transitory computer-readable storage medium comprising instructions that, when executed by at least one processor of a machine, cause the machine to perform operations for performing supplier management, comprising:
defining one or more social media metrics pertaining to a supplier brand of interest, the one or more social media metrics being based on data gathered from social media;
transmitting the one or more social media metrics to a web analyzer vendor;
receiving values for the one or more social media metrics from the web analyzer vendor;
assigning weights to the values received for the one or more metrics;
deriving a score for the supplier brand of interest based on the weighted values for the one or more social metrics and based on weighted, values for one or more other metrics; and
presenting the score to a user via a graphical user interface.

20. A non-transitory computer-readable storage medium comprising instructions that, when executed by at least one processor of a machine, cause the machine to perform operations for performing supplier management comprising:
defining one or more social media metrics pertaining to a supplier brand of interest, the one or more social media metrics being based on data gathered from social media;
monitoring social media for data;
using the data to evaluate the one or more social media metrics and deriving values for the one or more social media metrics;
assigning weights to the values derived for the one or mote metrics;
deriving a score for the supplier brand of Interest based on the weighted values for the one or more social metrics and based on weighted values for one or more other metrics; and
presenting the score to a user via a graphical user interface.
